(19) United States
(12) Patent Application Publication
(10) Pub. No.: US 2007/0035472 A1
(43) Pub. Date: Feb. 15, 2007

(54) Multi-Display System with Independent Operating Areas

(76) Inventor: Shun-Ping Wang, Taipei (TW)

Correspondence Address: NORTH AMERICA INTELLECTUAL PROPERTY CORPORATION, P.O. BOX 506, MERRIFIELD, VA, 22116, US

(21) Appl. No.: 11/463,895

(22) Filed: Aug. 11, 2006

(30) Foreign Application Priority Data
Aug. 11, 2005 (TW) 094127388

(51) Int. Cl. G09G 5/00

(52) U.S. Cl. 345/3.1

(57) ABSTRACT

A multi-display system includes a display module, a memory module, and a control module. The display module displays a first image and a second image, the memory module has at least a first operating area and a second operating area, and the control module utilizes the first operating area to store the first image and the second operating area to store the second image. The first image and second image operate independently in the multi-display system. The control module is a multi-display chip.

### BACKGROUND OF THE INVENTION

1. Field of the Invention

The present invention relates to multi-display systems, and more particularly to a multi-display system that utilizes a multi-display chip embedded in an electronic device to allow the electronic device to simultaneously display a first image and a second image that operate independently.

2. Description of the Prior Art

Please refer to FIG. 1. FIG. 1 illustrates a diagram of a display system according to the prior art. The display system is used in an electronic device, and the electronic device is a computer 11. The display system includes a display module 12, a memory module 13, and a central processing unit (CPU) 14. The CPU 14 installed within the computer 11 controls a first operating area 131 and a second operating area 132 of the memory module 13. The first operating area 131 stores a first image 121 of the display module 12, and the second operating area 132 stores a second image 132 of the display module 12.

Please continue to refer to FIG. 1. When a computer user utilizes an external device for giving a report, beyond utilizing a projector 15 as an external device, the CPU 14 controls the first operating area 131 or the second operating area 132 to act as an independent operating area of the computer 11. When the computer user selects the first image 121 as a main display of the computer 11 and uses the main display as an operating platform, the main display provides an output signal to the projector 15, so that the main display of the computer 11 and a projected image of the projector 15 are synchronized. Likewise, when the computer user selects the second image 122 to be the main display of the computer 11 and uses the main display to act as an operating platform, the main display provides the output signal to the projector 15, so that the main display of the computer 11 and the projected image of the projector 15 are synchronized.

Please refer to FIG. 2. FIG. 2 is an application diagram of a display system according to the prior art. When the computer 11 uses the projector 15 to project the main display 21 onto a screen 151, the main display 21 of the computer 11 and a projected image on the screen 151 are synchronized. Thus any operations executed or personal messages sent/received by the computer user on the main display of the computer 11 are also displayed on the screen 151 through the projector 15.

In today's busy business environment, whether it is a business report or an educational lecture, the computer is utilized as a data source for the projector. The computer user can edit the data of the report through the operating platform of the computer, but in the conventional display system, only the main display can act as the operating platform for the computer user. Hence when the computer is projecting the main display onto the screen through the projector, any operations executed or personal messages sent/received by the computer user are displayed on the screen. In conclusion, the conventional display system lacks confidentiality and an independent operating platform, therefore the present invention provides a multi-display system and related method to overcome the above-mentioned problems.

### SUMMARY OF THE INVENTION

A multi-display system applied to an electronic device according to the present invention comprises a display module installed within the electronic device for displaying a first image and a second image, a memory module installed within the electronic device comprising at least a first operating area and a second operating area, and a control module installed within the electronic device for utilizing the first operating area to store the first image and for utilizing the second operating area to store the second image, the first image and the second image operating independently. When the first image is used to transmit an output signal to an external device, operation in the second image is performed independently.

Further, a multi-display system applied to an electronic device according to the present invention comprises a display module installed within the electronic device for displaying a first image and a second image, a memory module installed within the electronic device comprising at least a first operating area and a second operating area, and a control module installed within the electronic device for storing the first image in the first operating area and the second image in the second operating area. The first image and the second image operate independently, and when the first image provides an output signal to an external device, operation in the second image is performed independently.

Finally, a method of displaying independent operating areas applied in an electronic device according to the present invention comprises storing a first image and a second image in the electronic device, transmitting an output signal corresponding to the first image to an external display device, and performing an operation in the second image without changing the output signal corresponding to the first image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a display system according to the prior art.

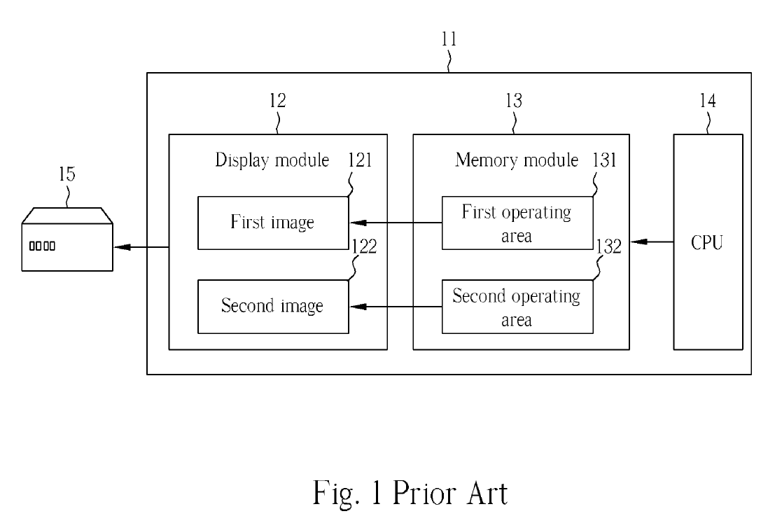

FIG. 2 is an application diagram of a display system according to the prior art.

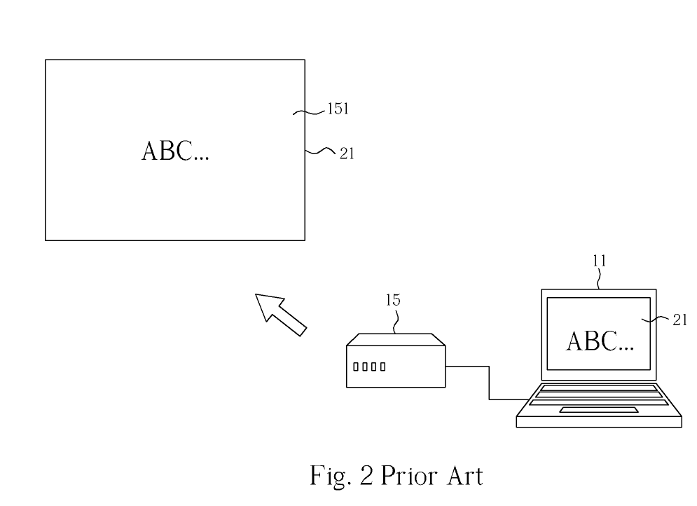

FIG. 3 is a diagram of a multi-display system according to the present invention.

FIG. 4 is an application diagram of a multi-display system according to the present invention.

FIG. 5 is a flowchart of a method of a multi-display system according to the present invention.

### DETAILED DESCRIPTION

Please refer to the following figures for a further explanation on a multi-display system and related method according to an embodiment of the present invention, where identical reference symbols will be applied on similar components for a clearer explanation.

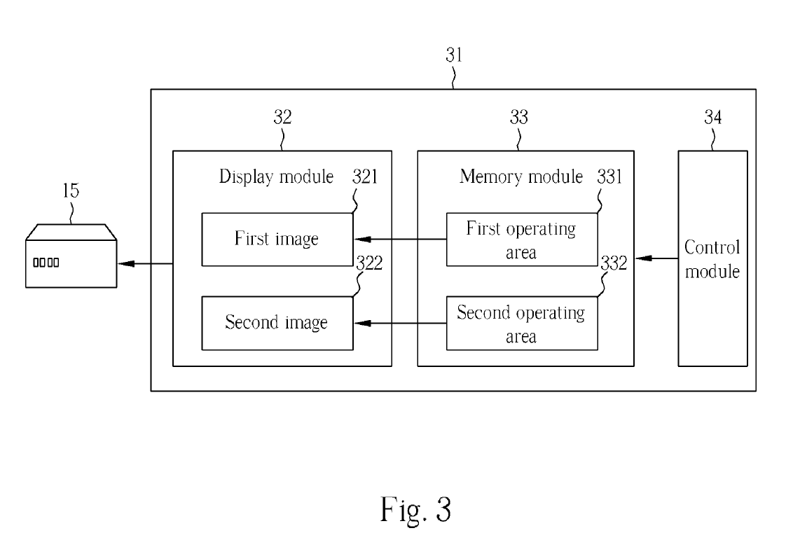

Please refer to FIG. 3. FIG. 3 is a diagram of a multi-display system according to the present invention. The multi-display system is applied to an electronic device, and the electronic device is a computer 31. The multi-display system includes a display module 32, a memory module 33, and a control module 34. The control module 34 installed within the computer 31 is a multi-display chip, and the multi-display chip is utilized to control a first operating area 331 and a second operating area 332 of the memory module 33. The first operating area 331 stores a first image 321 of the display module 32, and the second operating area 332 stores a second image 332 of the display module 32.

Please refer to FIG. 3 again. The multi-display chip is utilized as the control module 34 so that the memory module 33 and the display module 32 of the computer 31 can include the multi-display system functions. For example, when the computer user utilizes the external device to give a report, beyond utilizing the projector 15 as the external device, the control module 34 simultaneously controls the first operating area 331 and the second operating area 332 of the memory module 33, such that the computer 31 can simultaneously use two independent operating areas. The first operating area 331 stores the first image 321 of the display module 32 as a first image of the computer, and the second operating area 332 stores the second image 332 of the display module 32 as a second image of the computer. At this time, the first image of the computer and the second image of the computer operate independently, and both act as an operating platform for the computer user. When the computer user selects the first image of the computer and outputs a signal provided by the first image to the projector 15, the first image of the computer and a projected image of the projector 15 are synchronized. At this time, the second image of the computer can still execute an operation independently. Likewise, when the computer user selects the second image of the computer and outputs a signal provided by the second image to the projector 15, the second image of the computer and the projected image of the projector 15 are synchronized. At this time, the first image of the computer can still execute an operation independently. To conclude, the multi-display system can achieve execution of independent operating functions in both the first image of the computer and the second image of the computer.

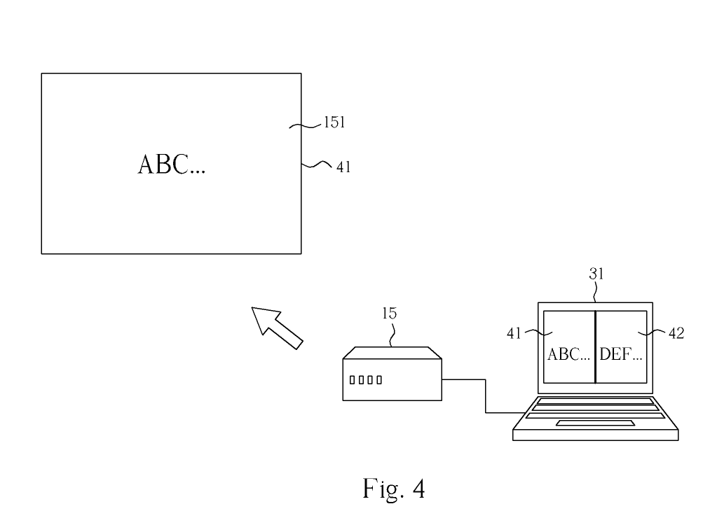

Please refer to FIG. 4. FIG. 4 is an application diagram of a multi-display system according to the present invention. When the computer 31 projects a first image 41 of the computer through the projector 15 onto a screen 151, the first image 41 of the computer and the projected image on the screen 151 are synchronized. At this time, a second image 42 of the computer can independently execute an operation for the computer user. In another words, when the computer user is executing an operation or processing personal messages on the second image 42 of the computer, the operation of the first image 41 of the computer outputting signals to the projector is not affected. In conclusion, the present invention overcomes the lack of confidentiality and the lack of independent platforms of the prior art display system.

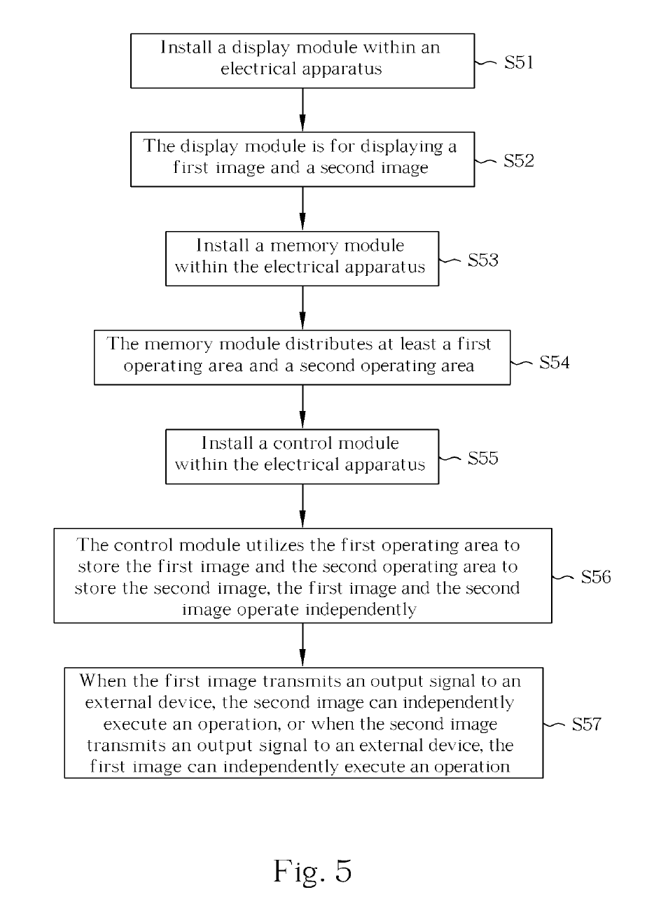

Please refer to FIG. 5. FIG. 5 is a flowchart of a method displaying multiple operating areas in an electronic device according to the present invention. A display module is installed within an electronic device in step S51, and in step S52 the display module is utilized for displaying a first image and a second image. A memory module is installed within the electronic device in step S53, and in step S54 the memory module distributes at least a first operating area and a second operating area. A control module is installed within the electronic device in step S55, and in step S56 the control module utilizes the first operating area to store the first image and utilizes the second operating area store to store the second image. The first image and the second image operate independently. In step S57, when the first image transmits an output signal to an external device, the second image can independently execute an operation, or when the second image transmits the output signal to the external device, the first image can independently execute the operation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-display system applied to an electronic device, the system comprising:
a display module installed within the electronic device for displaying a first image and a second image;
a memory module installed within the electronic device comprising at least a first operating area and a second operating area; and
a control module installed within the electronic device for utilizing the first operating area to store the first image and for utilizing the second operating area to store the second image, the first image and the second image operating independently;
wherein when the first image is used to transmit an output signal to an external device, operation in the second image is performed independently.

2. The multi-display system of claim 1 wherein the electronic device is a computer.

3. The multi-display system of claim 1 wherein the control module is a multi-display chip.

4. The multi-display system of claim 1 wherein the external device is a projector.

5. A method of displaying independent operating areas applied in an electronic device, the method comprising:
at least storing a first image and a second image in the electronic device;
transmitting an output signal corresponding to the first image to an external display device; and
performing an operation in the second image without changing the output signal corresponding to the first image.

6. The method of claim 5, wherein performing the operation in the second image without changing the output signal corresponding to the first image comprises using a multi-display chip.

7. The method of claim 5 wherein transmitting the output signal corresponding to the first image to the external display device is transmitting the output signal corresponding to the first image to a projector.

8. A multi-display system applied to an electronic device, the system comprising:
a display module installed within the electronic device for displaying a first image and a second image;
a memory module installed within the electronic device comprising at least a first operating area and a second operating area; and
a control module installed within the electronic device for storing the first image in the first operating area and the second image in the second operating area;
wherein the first image and the second image operate independently, and when the first image provides an output signal to an external device, operation in the second image is performed independently.
